(19) United States
(12) Patent Application Publication
(10) Pub. No.: US 2011/0083371 A1
(43) Pub. Date: Apr. 14, 2011

(54) Retractable screen door system

(76) Inventors: Brian G. Hughes, Indian Lake Estates, FL (US); Brian E. Jones, Hoschton, GA (US)

(21) Appl. No.: 12/800,737

(22) Filed: May 21, 2010

Related U.S. Application Data
(63) Continuation-in-part of application No. 12/587,860, filed on Oct. 14, 2009.

(51) Int. Cl. E05F 11/54; E06B 3/50; E05D 15/38

(52) U.S. Cl. 49/199; 160/368.1

(57) ABSTRACT

A retractable screen door system has a flexible door with a free vertical edge and horizontal upper and lower edges and a vertical constrained edge. A recipient structure has an opening bounded by horizontal upper and lower rails and a fixed post and hollow housing post. A flexible screen door has a free vertical edge and horizontal upper and lower edges and a vertical constrained edge. A cylindrically shaped spring cartridge is located in the housing post to receive and support the constrained edge of the screen door. Upper and lower end caps are between the cartridge and the rails. Spline grooves are formed in the rails and in the upper end cap and the hollow housing post and the lower end cap to facilitate the efficient mounting of screen material and spline.

### RELATED APPLICATIONS

The present patent application is a continuation-in-part of U.S. patent application Ser. No. 12/587,860 filed Oct. 14, 2009 entitled Garage Screen Door System, the subject matter of which application is incorporated herein by reference.

### BACKGROUND OF THE INVENTION

### Field of the Invention

The present invention relates to a garage screen door system and more particularly pertains to providing a supplemental single panel garage door having a centrally positioned retractable screen door, in a safe, convenient, eye-appealing and cost effective manner.

### SUMMARY OF THE INVENTION

In view of the foregoing disadvantages inherent in the known types of garage door systems now present in the prior art, the present invention provides an improved garage screen door system. As such, the general purpose of the present invention, which will be described subsequently in greater detail, is to provide a new and improved garage screen door system and method which has all the advantages of the prior art and none of the disadvantages.

To attain this, the present invention essentially comprises a one piece garage door having an opening there through. The opening is fixedly bounded by a horizontal upper rail and a horizontal lower rail, a vertical fixed post and a hollow vertical housing post. The hollow vertical housing post is formed with a vertical open slot running the length of the post. The vertical open slot permits access to the interior of the hollow vertical housing post.

Next, a flexible screen door is provided. The flexible screen door has a free vertical edge with a rigid vertical support. The screen door has horizontal upper and lower edges. The screen door has a vertical constrained edge. The screen door passes through the open slot on the hollow vertical housing post with the free vertical edge remaining on the exterior of the hollow vertical housing post and the vertical constrained edge being on the interior of the hollow vertical housing post.

An upper track attached to the upper rail and a lower track attached to the lower rail are next provided. The tracks are adapted to slidably support the upper and lower edges of the screen door for reciprocal movement.

Next provided is a cylindrically shaped spring cartridge. The spring cartridge is located in the interior of the housing post with upper and lower ends mounted for rotational movement about a vertical axis. The spring cartridge has an exterior surface receiving and supporting the constrained edge of the screen door. In this manner, rotation of the cartridge in a first direction will allow the screen door to cover the opening while rotation of the cartridge in an opposite second direction will allow the door to uncover the opening.

Next, an upper end cap between the upper end of the cartridge and the upper rail is provided. Also a lower end cap is provided between the lower end of the cartridge and the lower rail. A plurality of self-tapping screws couple the end caps to the rails and to the cartridge. The upper end of the cartridge is formed with an upstanding tab. The upper end cap is formed with a slot receiving the tab for controlling the rotation of the cartridge and reciprocation of the door. Each end cap has a lateral projection receiving and supporting the upper and lower tracks. Vertically extending short posts are formed in each end cap and received in the upper and lower ends of the hollow vertical housing post to provide rigidity.

Lastly, horizontal spline grooves are formed in the upper and lower rails. Vertical spline grooves are formed in alignment in the upper end cap and the housing post and the lower end cap. The spline groove on the hollow housing post is located on the corner of the hollow housing post which is obliquely opposite to the open vertical slot. The spline grooves are adapted to receive and support screens and splines while allowing for efficient screen replacement.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved garage screen door system which has all of the advantages of the prior art for garage screen door systems and none of the disadvantages.

It is another object of the present invention to provide a new and improved garage screen door system which may be easily and efficiently manufactured and marketed.

It is further object of the present invention to provide a new and improved garage screen door system which is of durable and reliable constructions.

An even further object of the present invention is to provide a new and improved garage screen door system which is susceptible of a low cost of manufacture with regard to both materials and labor, and which accordingly is then susceptible of low prices of sale to the consuming public, thereby making such garage screen door system economically available to the buying public.

Even still another object of the present invention is to provide a garage screen door system for providing a supplemental single panel garage door having a centrally positioned retractable screen door, in a safe, convenient, eye-appealing and cost effective manner.

Lastly, it is an object of the present invention to provide a new and improved retractable door system having a flexible door with a free vertical edge and horizontal upper and lower edges and a vertical constrained edge. A recipient structure has an opening bounded by horizontal upper and lower rails and a fixed post and hollow housing post. A flexible door has a free vertical edge and horizontal upper and lower edges and a vertical constrained edge. A cylindrically shaped spring cartridge is located in the hollow housing post to receive and support the constrained edge of the door. Upper and lower end caps are between the cartridge and the rails. Spline grooves are formed in the rails and in the upper end cap and the housing post and the lower end cap. The flexible door moves from the closed to the open position and vice versa by being unrolled through the open slot along the interior face of the hollow housing post.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated a primary and preferred embodiment of the invention as well as an alternate embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of a garage screen door system constructed in accordance with the principles of the present invention.

FIG. 2 is an enlarged front elevational view of the central portion of the system shown in FIG. 1 but with the screen door closed.

FIG. 3 is an enlarged front elevational view of the central portion of the system taken at Circle 3 of FIG. 2.

FIG. 4 is a cross sectional view taken at line 4-4 of FIG. 2.

FIG. 5 is an end elevational view of the system taken along line 5-5 of FIG. 1.

FIG. 6 is a plan view of the system taken along line 6-6 of FIG. 5.

FIG. 7 is a cross sectional view taken at line 7-7 of FIG. 6.

FIG. 8 is a front elevational view similar to FIG. 1 but illustrating an alternative embodiment of the invention.

FIG. 9 is a plan view taken at line 9-9 of FIG. 8 but with the door, shown in broken lines, in an open orientation.

FIG. 10 is front elevational view of a garage door system constructed in accordance with another alternate embodiment of the invention.

FIG. 11 is a front elevational view of a retractable screen door system constructed in accordance with the principles of the present invention.

FIG. 12 is an enlarged front elevational view of the system taken at circle 12 of FIG. 11.

FIG. 13 is an enlarged front elevational view of the system taken at circle 13 of FIG. 11.

FIG. 14 is a cross sectional view of the system taken along line 14-14 of FIG. 11.

FIGS. 14A and 14B are cross sectional views showing spline grooves shaped in accordance with alternate embodiments of the invention.

FIG. 15 is an exploded perspective illustration of the components shown in FIG. 12.

FIG. 16 is an exploded perspective illustration of the components shown in FIG. 13.

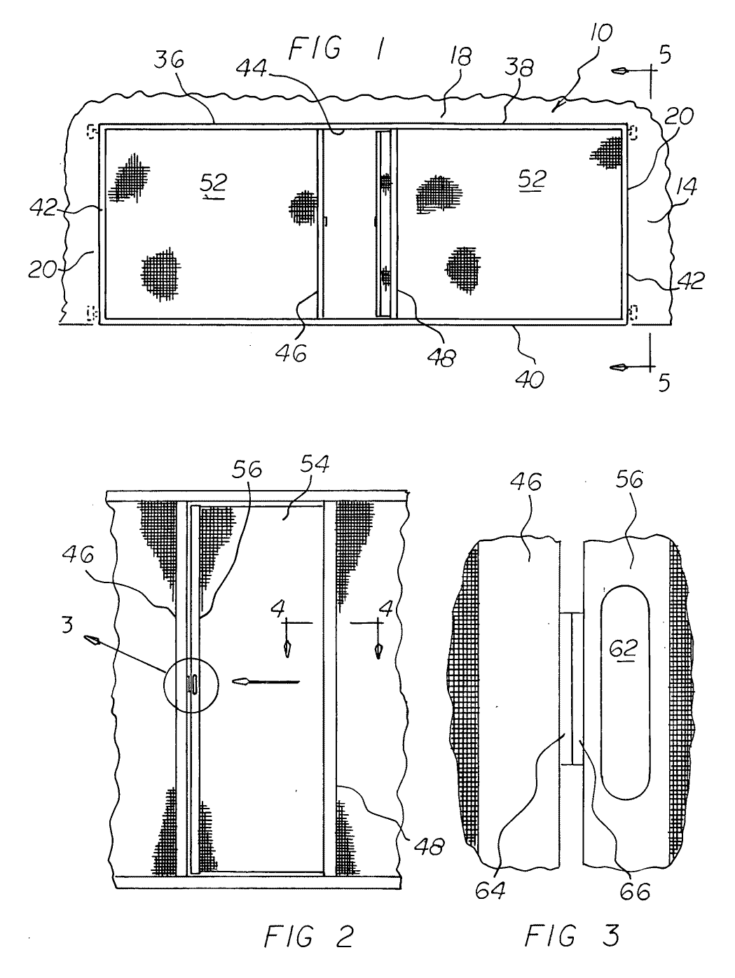

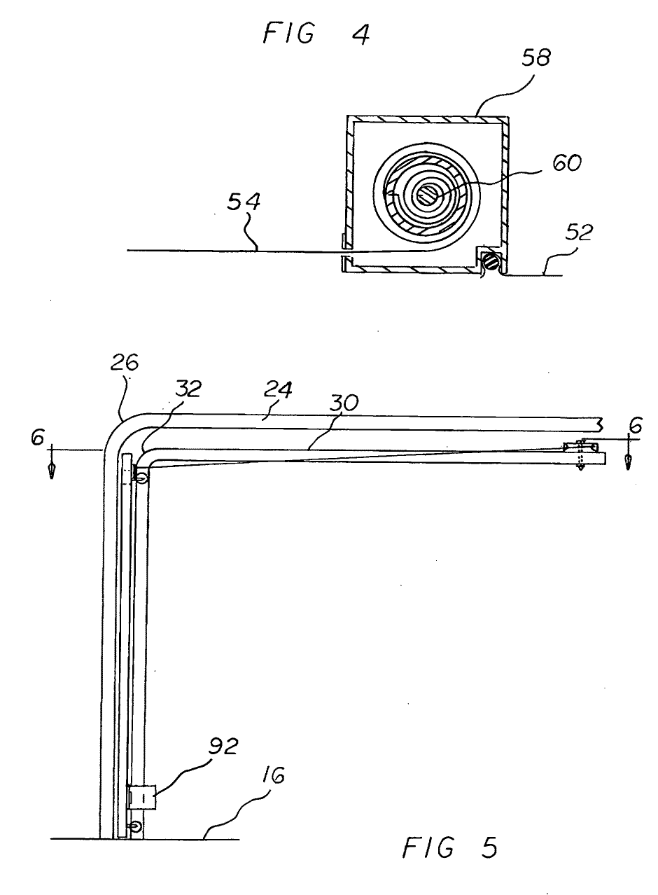

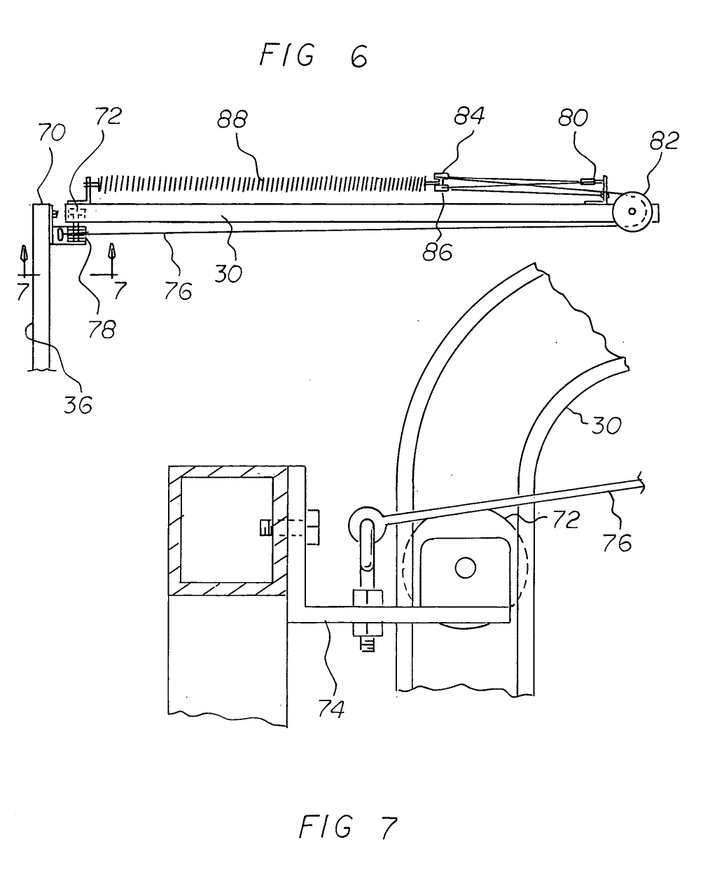

The same reference numerals refer to the same parts throughout the various Figures.

### DESCRIPTION OF THE PREFERRED EMBODIMENTS

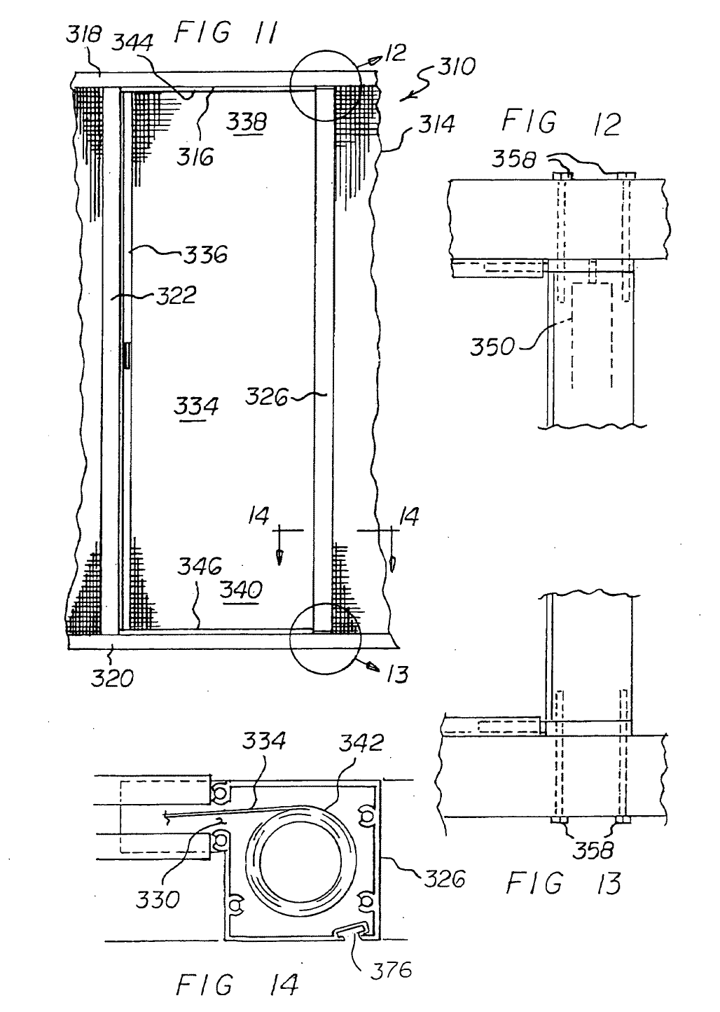

With reference now to the drawings, and in particular to FIGS. 1 and 11 thereof, the preferred embodiments of the new and improved garage screen door system and retractable screen door system embodying the principles and concepts of the present invention and generally designated by the reference numerals 10 and 310 will be described.

The garage screen door system 10 of the present invention is comprised of a plurality of components. Such components in their broadest context include two vertical tracks, a single panel garage door, a rectangular portal and a screen door. Such components are individually configured and correlated with respect to each other so as to attain the desired objective.

First provided is a garage 14. The garage has a chamber with a front opening. The garage has a horizontal floor 16. The garage has a parallel ceiling 18. The ceiling is spaced for a garage door with a height of between about 6 feet and about 16 feet. The garage has vertical side walls 20. The side walls are spaced for a garage door with a width of between about 8 feet and about 20 feet.

Primary tracks 24 are provided. Each track is in an inverted L-shaped configuration. Each track is mounted to a side wall. Each primary track has a vertical section within the chamber adjacent to the front opening. Each track has a horizontal section extending into the chamber. Each primary track has a curved intermediate section 26. The intermediate section has a radius of curvature of about 15 inches. Each primary track is adapted to receive and support a primary garage door. In this manner movement is allowed between a closed orientation between the vertical sections and an open orientation between the horizontal sections.

Secondary tracks 30 are provided. Each secondary track is in an inverted L-shaped configuration. Each secondary track is mounted with respect to a side wall. Each secondary track has a vertical section adjacent to the front opening. Each secondary track has a horizontal section extending into the chamber and depending from the primary track. Each secondary track has a curved intermediate section 32. The intermediate section has a radius of curvature of about 4 inches. The secondary track with its intermediate section is radially interior of and spaced a common distance from the primary track.

Provided next is a single panel secondary garage door 36. The secondary garage door has upper and lower rails 38,40. The secondary garage door has side rails 42. The rails are mounted for movement in the secondary tracks between a closed orientation between the vertical sections and an open orientation between the horizontal sections.

A rectangular portal 44 is provided next. The rectangular portal is centrally positioned within the secondary garage door. First and second vertical door rails 46, 48 are provided. In this manner the lateral extent of the portal and central extents of the upper and lower rails define the elevational extent of the portal.

Major screens 52 are provided. The major screens are secured laterally between one of the side rails and an adjacent vertical door rail. Each major screen is secured elevationally between the upper and lower rails at locations remote from the portal.

Further provided is a screen door 54. The screen door is formed of a flexible screen. The screen door has a height essentially equal to the height of the portal. The screen door has a width greater than the width of the portal. The flexible screen has an exterior end. The exterior end has a vertical support 56. The screen door has an interior end. A vertical housing 58 is provided. The vertical housing is coupled with the second vertical door rail. The housing has a spring loaded spool 60. The spool receives the flexible screen. In this manner movement of the flexible screen between a closed orientation covering the portal and an open orientation within the housing is allowed. The vertical support has a handle 62. The vertical support encompasses the spool. In this manner the opening and closing the screen door is facilitated. The first vertical door rail and the vertical support have magnets 64, 66. In this manner the flexible screen is maintained in a closed orientation.

Provided next is a lifting assembly 70 for the secondary garage door. The lifting assembly includes a 2 inch roller 72. The 2 inch roller extends outwardly with respect to each end of the upper and lower rails. The rollers are received for movement within the secondary tracks. The lifting assembly includes a first bracket 74. The first bracket couples the upper rail and one of the rollers. The lifting assembly includes a cable 76. The cable has a first end 78. The first end is coupled to the first bracket. The cable has a second end 80. The second end is laterally secured with respect to the horizontal section of the secondary track remote from the front opening. The lifting assembly includes a major pulley 82. The lifting assembly includes secondary pulleys 84, 86. The pulleys guide the movement of the screen door when lifting and lowering. The lifting assembly also includes a coil spring 88. The coil spring couples the secondary pulleys with respect to the horizontal section of the secondary track adjacent to the front opening. In this manner the strength needed to lift and lower the secondary garage door is minimized.

Lastly provided is a beam deflector 92 secured to the secondary garage door adjacent to one side of the lower rail. The beam deflector is adapted to disrupt an electric eye light beam normally extending close to the floor from one side wall of the opening to the other side wall of the opening. This is for functioning as a safety measure to preclude interference between the primary garage door and secondary garage door while moving between the open and closed orientations.

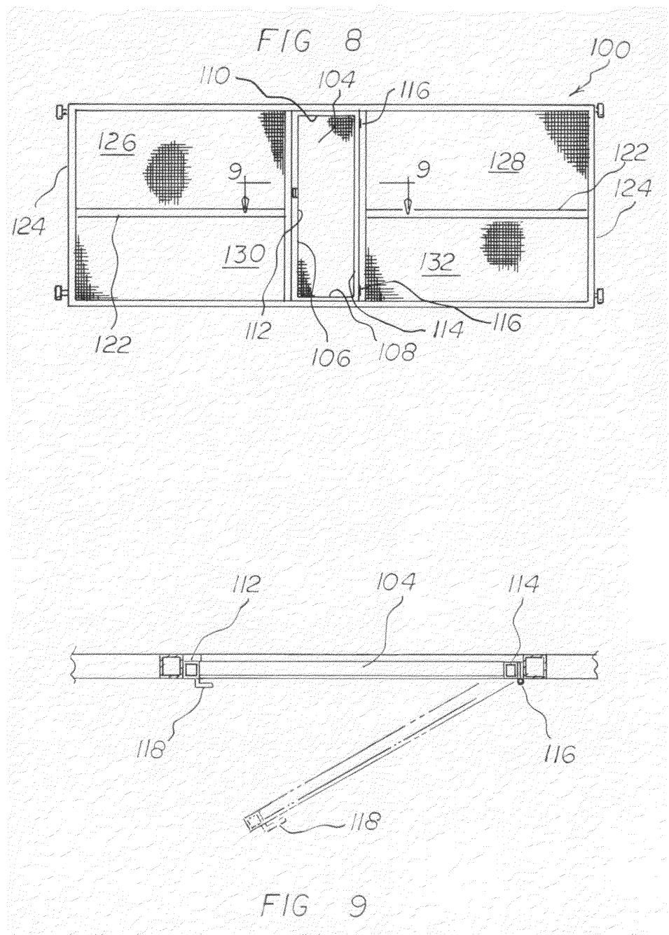

Reference in now made to the alternate embodiment 100 of the invention as illustrated in FIGS. 8 and 9. A screen door 104 is provided. The screen door is in a rectangular configuration. The screen door includes a frame 106. The frame has a horizontal lower rail 108. The frame has a parallel upper rail 110. The upper and lower rails are spaced by a height essentially equal to the height of the portal. The frame has vertical side rails 112, 114. The side rails couple the upper and lower rails. The side rails are spaced by a width essentially equal to the width of the portal. The frame further includes hinges 116. The hinges pivotally couple the screen door to the garage door. The screen door has a handle 118. In this manner opening and closing of the screen door is facilitated.

A chair rail 122 is provided. An end rail 124 is provided. The chair rail is horizontally supported on the garage door between the end rail and an adjacent vertical side rail of the frame. The major screening is in four sections. Two sections 126, 128 are located on each vertical side rail of the frame above the chair rail. Two sections 130, 132 are located on each vertical side rail of the frame below the chair rail.

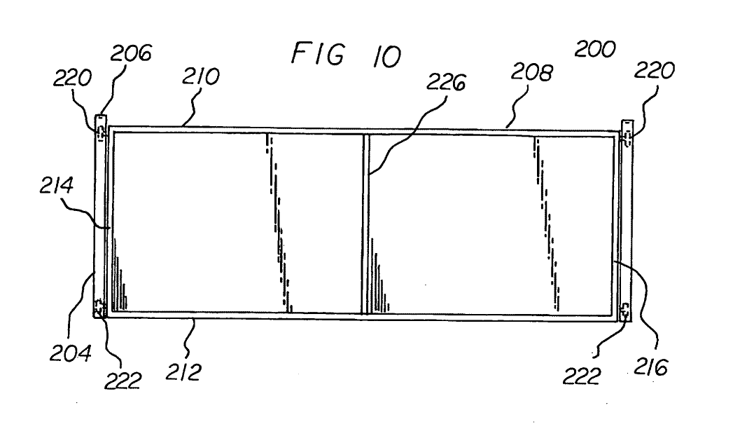

FIG. 10 illustrates another embodiment of the invention. In such embodiment, a garage door system 200 is provided.

Such garage door system comprises two laterally spaced tracks. Each track is formed in an inverted L-shaped configuration with a vertical section 204 and a horizontal section 206.

A single panel garage door 208 is next provided. Such garage door has a rigid peripheral frame formed with a horizontal upper rigid rail 210 and a parallel lower rigid rail 212 and laterally spaced side rigid rails 214, 216 between the upper and lower rigid rails. The garage door is adapted to be fabricated of any suitable material with or without windows.

A pair of upper rollers 220 extend outwardly from adjacent to the upper rigid rail. A pair of lower rollers 222 extend outwardly from adjacent to the lower rigid rail. The two pair of rollers are slidably received in the tracks.

Lastly, a divider rail 226 extends between the upper and lower rigid rails parallel with the side rigid rails. The divider rail is adapted to be used in the installation of a service door which may later be formed in the garage door. Like the garage door, the service door is adapted to be fabricated of any suitable material.

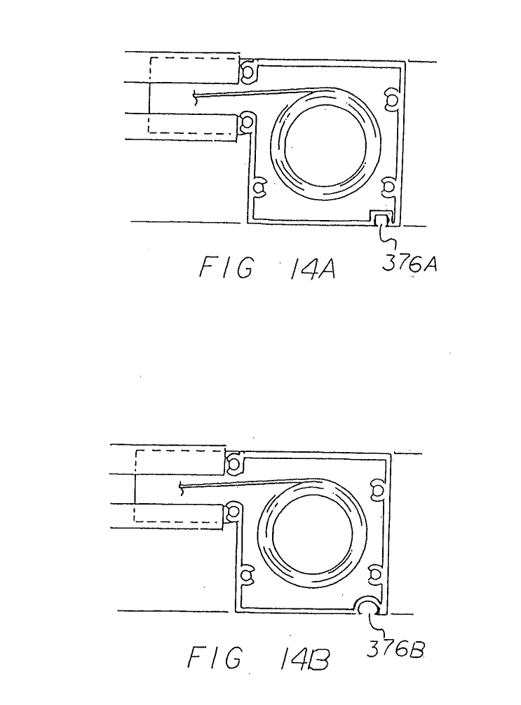

Reference is now made to FIGS. 11 through 16 which illustrates the retractable screen door system 310 of the present invention. The retractable screen door system is for rotationally extending a screen door for use and for rotationally retracting the screen door for storage. The extending and retracting is done in a safe, reliable, convenient and economical manner.

First provided in the preferred embodiment of the retractable screen door system is a one piece garage door 314 having an opening 316 there through. The opening is fixedly bounded by a horizontal upper rail 318 and a horizontal lower rail 320, a vertical fixed post 322 and a hollow vertical housing post 326. The hollow vertical housing post is formed with a vertical open slot 330.

Next, a flexible screen door 334 is provided. The flexible screen door has a free vertical edge with a rigid vertical support 336. The screen door has horizontal upper and lower edges 338, 340. The screen door has a vertical constrained edge 342.

An upper track 344 attached to the upper rail and a lower track 346 attached to the lower rail are next provided. The tracks are adapted to slidably support the upper and lower edges of the screen door for reciprocal movement.

Next provided is a cylindrically shaped spring cartridge 350. The spring cartridge is located in the housing post with upper and lower ends mounted for rotational movement about a vertical axis. The spring cartridge has an exterior surface receiving and supporting the constrained edge of the screen door. In this manner, rotation of the cartridge in a first direction will allow the screen door to cover the opening 316 while rotation of the cartridge in an opposite second direction will allow the door to uncover the opening.

Next, an upper end cap 354 between the upper end of the cartridge and the upper rail is provided. Also a lower end cap 356 is provided between the lower end of the cartridge and the lower rail. A plurality of self-tapping screws 358 couple the end caps to the rails and to the cartridge. The upper end of the cartridge is formed with an upstanding tab 360. The upper end cap is formed with a slot 362 receiving the upstanding tab for controlling the rotation of the cartridge and reciprocation of the door. Each end cap has a lateral projection 364 receiving and supporting the upper and lower tracks. Vertically extending short posts 366 are formed in each end cap and received in the upper and lower ends of the hollow housing post to provide rigidity.

Lastly, horizontal spline grooves 370, 372 are formed in the upper and lower rails. Vertical spline grooves 374, 376, 378 are formed in alignment in the upper end cap and the housing post and the lower end cap. The spline grooves are adapted to receive and support screens and splines while allowing for efficient screen replacement.

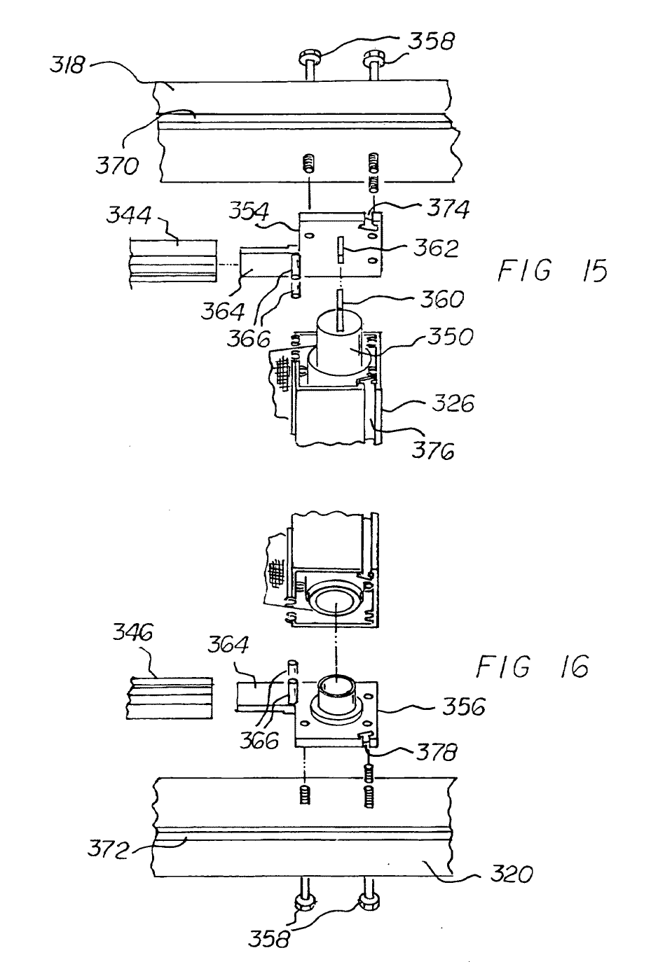

FIGS. 14, 15 and 16 illustrate the preferred embodiment of the invention with the spline grooves for the end caps and the housing post being in an angularly disposed, rectangular configuration. Alternate configurations of spine grooves for different types of splines are included in the present invention. One alternate configuration includes essentially square spline grooves 376A as shown in FIG. 14A. Another alternate configuration includes essentially circular spline grooves 376B as shown in FIG. 14B.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A retractable door system comprising:
a recipient structure having an opening bounded by horizontal upper and lower rails and a fixed post and hollow housing post;
a flexible door having a free vertical edge and horizontal upper and lower edges and a vertical constrained edge;
a cylindrically shaped spring cartridge located in the hollow housing post, the spring cartridge receiving and supporting the constrained edge of the door;
upper and lower end caps between the cartridge and the rails; and
spline grooves formed in the rails and in the upper end cap and the housing post and the lower end cap.

2. The system as set forth in claim 1 wherein the spline grooves are in an angularly disposed, rectangular configuration.

3. The system as set forth in claim 1 wherein the spline grooves (376A) are in an essentially square spline configuration.

4. The system as set forth in claim 1 wherein the spline grooves (376A) are in an essentially circular configuration.

5. The system as set forth in claim 1 and further including:
a plurality of self-tapping screws coupling the end caps to the rails and to the cartridge.

6. The system as set forth in claim 1 wherein the upper end of the cartridge is formed with an upstanding tab and the upper end cap is formed with a slot receiving the upstanding tab for controlling the rotation of the cartridge and reciprocation of the door.

7. The system as set forth in claim 1 and further including:
upper and lower tracks secured to the upper and lower rails for guiding the reciprocation of the screen door; and
wherein each end cap has a lateral projection receiving and supporting the upper and lower tracks.

8. A retractable screen door system (310) for rotationally extending a screen door for use and for rotationally retracting the screen door for storage, the system comprising in combination:
a one piece garage door (314) having an opening (316) there through, the opening being fixedly bounded by a horizontal upper rail (318) and a horizontal lower rail (320) and a vertical fixed post (322) and having hollow vertical housing post (326) formed with a vertical open slot (330) running the length of the post;
a flexible screen door (334) having a free vertical edge with a rigid vertical support (336), the screen door having a horizontal upper and lower edges (338), (340), the screen door having a vertical constrained edge (342);
an upper track (344) attached to the upper rail and a lower track (346) attached to the lower rail, the tracks adapted to slidably contain the upper and lower edges of the screen door for reciprocal movement;
a cylindrically shaped spring cartridge (350) located in the housing post with upper and lower ends mounted for rotational movement about a vertical axis, the spring cartridge having an exterior surface receiving and supporting the constrained edge of the screen door whereby rotation of the cartridge in a first direction will allow the screen door to cover the opening (316) while rotation of the cartridge in an opposite second direction will allow the door to uncover the opening;
an upper end cap (354) between the upper end of the cartridge and the upper rail, a lower end cap (356) between the lower end of the cartridge and the lower rail, a plurality of self-tapping screws (358) coupling the end caps to the rails and to the cartridge, the upper end of the cartridge being formed with an upstanding tab (360), the upper end cap being formed with a slot (362) receiving the upstanding tab for controlling the rotation of the cartridge and reciprocation of the door, each end cap having a lateral projection (364) receiving and supporting the upper and lower tracks, vertically extending short posts (366) formed in each end cap received in the upper and lower ends of the hollow housing post to provide rigidity; and
horizontal spline grooves (370), (372) formed in the upper and lower rails, vertical spline grooves (374), (376), (378) formed in alignment in the upper end cap and the housing post and the lower end cap, the spline grooves adapted to receive and support screens and splines while allowing for efficient screen replacement.
